(19) United States
(12) Patent Application Publication
(10) Pub. No.: US 2007/0291341 A1
(43) Pub. Date: Dec. 20, 2007

(54) Decorative lighting apparatus

(75) Inventor: Kuo-An Pan, Hong Kong (CN)

Correspondence Address: OBLON, SPIVAK, MCCLELLAND MAIER & NEUSTADT, P.C., 1940 DUKE STREET, ALEXANDRIA, VA, 22314, US

(73) Assignee: Everstar Merchandise Co., Ltd., Hong Kong (CN)

(21) Appl. No.: 11/454,928

(22) Filed: Jun. 19, 2006

(51) Int. Cl. G02B 5/32

(52) U.S. Cl. 359/15; 359/1

(57) ABSTRACT

A decorative lighting apparatus includes a structure, a plurality of light emitting elements supported by the structure, and a diffractive surface. The diffractive surface is connected to the structure such that the plurality of light emitting elements is behind the diffractive surface. The plurality of light emitting elements is configured to emit light through the diffractive surface to a viewer. The diffractive surface includes a rainbow hologram.

### BACKGROUND OF THE INVENTION

1. Field of the Invention

The present invention relates to decorative lighting apparatuses. More specifically, the present invention relates to decorative lighting apparatuses including a diffraction grating.

2. Description of the Related Art

Decorative lighting apparatuses are often used as holiday decorations, especially for holidays such as Christmas and Halloween. However, related decorative lighting apparatuses typically include a light located above a reflective surface, which has a limited interest as the decoration looks very similar from different viewing angles. Accordingly, a more interesting decoration is desired, especially a decoration that changes as a viewer changes position with respect to the decoration.

### SUMMARY OF THE INVENTION

The present invention broadly comprises a decorative lighting apparatus including a structure, a plurality of light emitting elements supported by the structure, and a diffractive surface. The diffractive surface is connected to the structure such that the plurality of light emitting elements is behind the diffractive surface. The plurality of light emitting elements is configured to emit light through the diffractive surface to a viewer. The diffractive surface includes a rainbow hologram.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a front view of a first embodiment of the present invention;

FIG. 2 shows a rear view of a first embodiment of the present invention;

FIG. 3 shows a side view of a first embodiment of the present invention;

FIG. 4 shows a perspective blow up view of a head of a snowman;

FIG. 5 shows a perspective blow up view of a snowman;

FIG. 6 shows a cutaway perspective view of a light source and diffraction grating;

FIG. 7 shows a cutaway view of a light emitting element;

FIG. 8 shows a cutaway view of a corner of a structure of the present invention; and

FIG. 9 shows a front view of a second embodiment of the present invention.

### DETAILED DESCRIPTION OF THE PREFERRED EMBODIMENTS

Referring now to the drawings, wherein like reference numerals designate identical or corresponding parts throughout the several views.

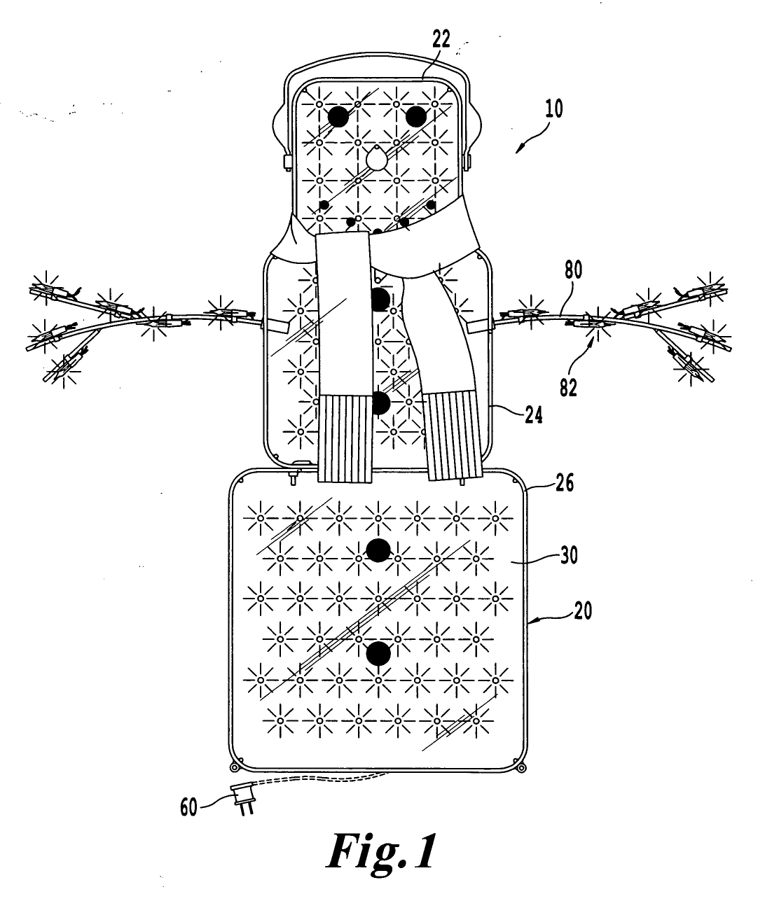

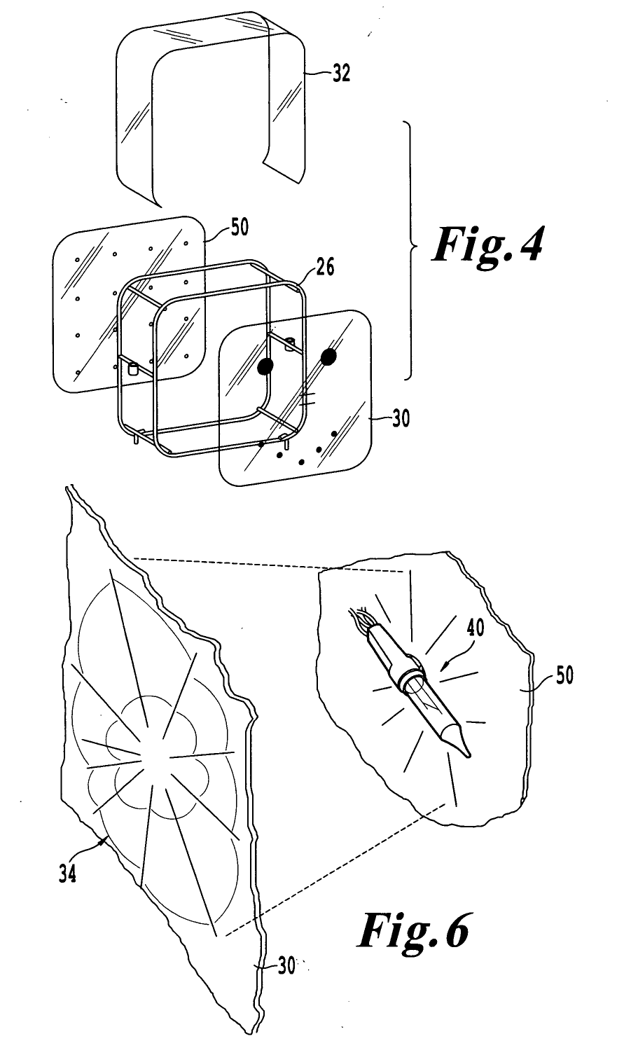

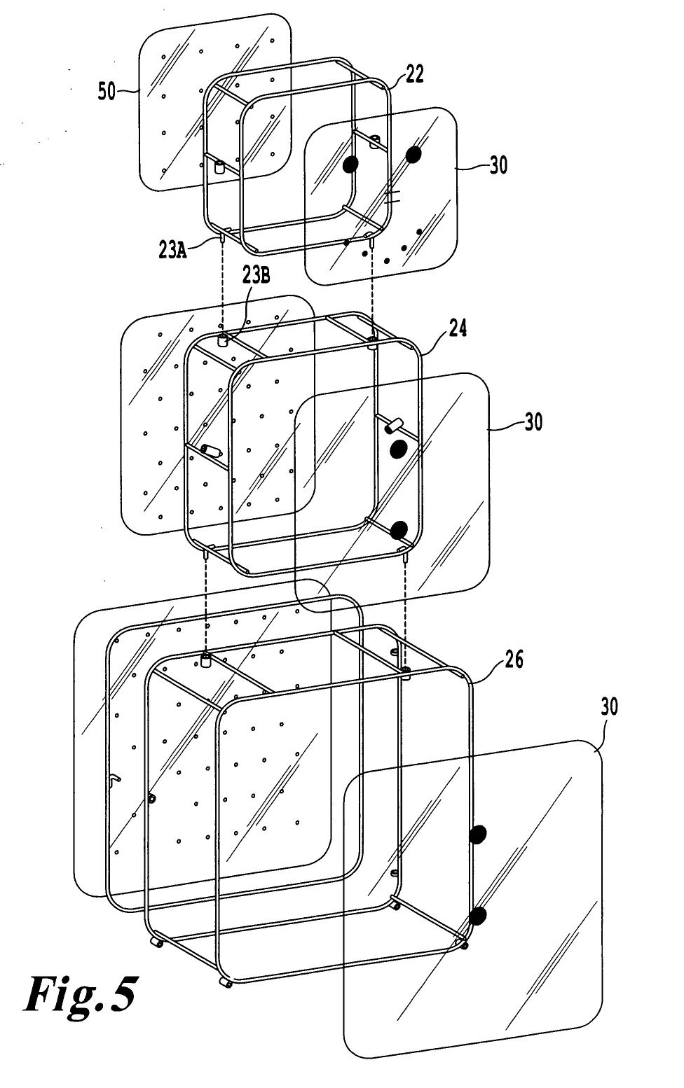

FIG. 1 shows a front view of a first embodiment of the present invention. Decorative lighting apparatus 10 includes a structure 20 including body sections 22, 24, and 26. As shown in FIGS. 4 and 5, support members 50 and diffractive surfaces 30 and 32 are connected to the body sections 22, 24, and 26.

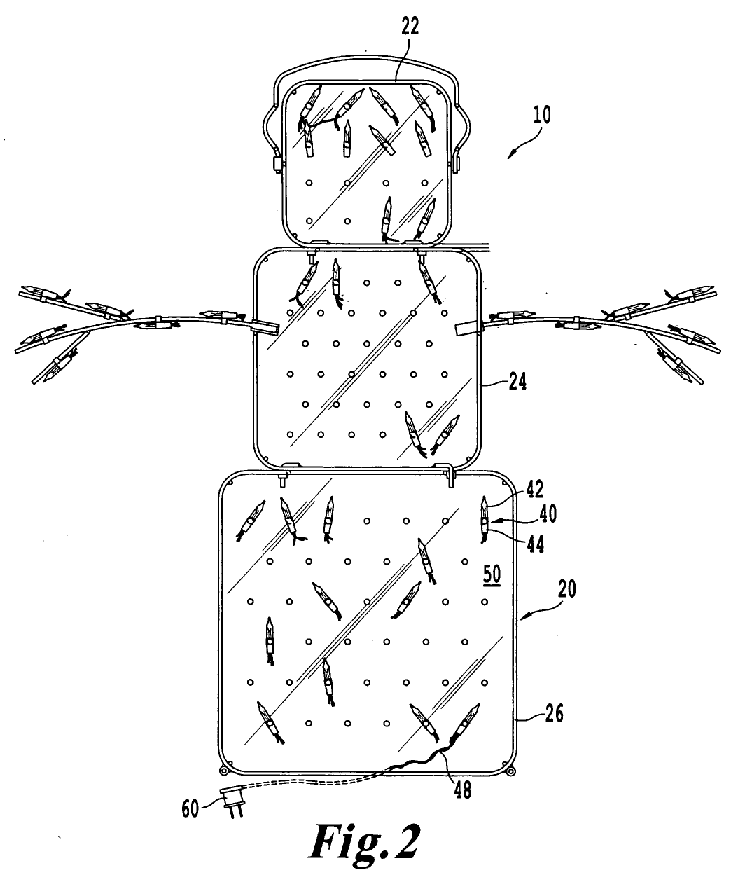

FIG. 2 illustrates that a plurality of light emitting elements 40 are connected to support members 30. Light emitting elements 40 are connected to each other and to plug 60 by current carrying wires 48. Light emitting elements include a bulb 42, a socket 44, and a fastener 46 (shown in FIG. 7).

As shown in FIG. 7, fastener 46 is inserted in apertures 52 of support member 50 to removably attach element 40 to the support member 50. Light emitting elements 40 may be light bulbs, light emitting diodes, or any other light emitting element known in the art. Further, light emitting elements 40 may be steady emitting or flashing elements, as known in the art. Light emitting elements 40 may be included on a single string of light emitting elements, or multiple strings of light emitting elements may be incorporated into the present invention.

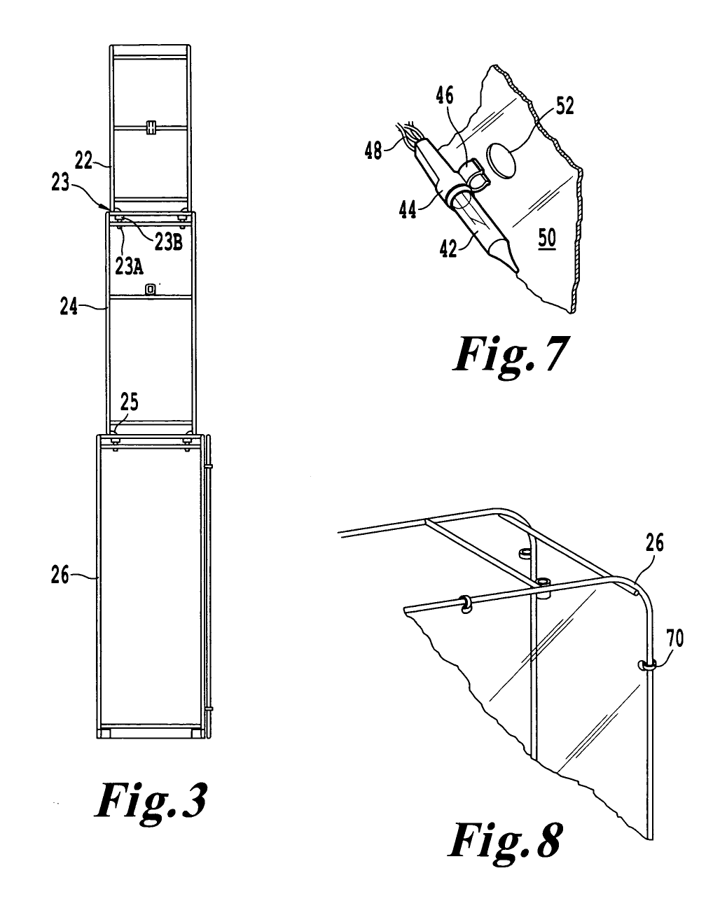

FIG. 3 shows a side view of the apparatus 10. Body sections 22, 24, and 26 include fasteners 23 and 25 to removably fasten the body sections together. Sections 22 and 24 are fastened together by fastener 23 and sections 24 and 26 are fastened together by fastener 25. As shown in FIG. 3, fastener 23 includes a projection 23A that is received by aperture 23B. However, any fastener known in the art may be used to connect the body sections.

FIG. 4 shows that diffraction surface 30 is connected to a front side of structure 20, and support member 50 is connected to a back side. In addition, as shown in FIG. 5, diffractive surface 32 may be connected to a side surface of structure 20.

FIG. 6 shows a cutaway illustration of light emitting element 40, support member 50, and diffractive surface 30. Light emitting element 40 is fixed to support member 50 such that light is emitted from the element 40 through diffractive surface 30 and to an observer facing the front of structure 20. When the light passes through diffractive surface 30, a visible diffraction pattern 34 is created, providing a pleasing visual appearance to an observer. When the observer changes position with respect to the apparatus 10, the diffraction pattern 34 continually changes, creating an interesting visual effect. This effect is extended for an even wider range of movement of the observer if diffraction surfaces 32 are included on the sides of structure 20. In either case, an interesting decorative lighting apparatus is provided by the present invention.

In one embodiment, diffractive surface 30 includes a rainbow hologram. Rainbow holograms are well known in the art, having been invented in 1968 by Dr. Stephen Benton. It should be readily apparent to one skilled in the art how to make and use a diffractive surface including a rainbow hologram as shown in FIGS. 1-9. Further, diffractive surface 30 may be a transparent or translucent surface.

Support member 50 is connected to structure 20 around a periphery of the member by fasteners 70, as shown in FIG. 8. Diffractive surfaces 30 and 32 may also be connected to structure 20 by fasteners 70.

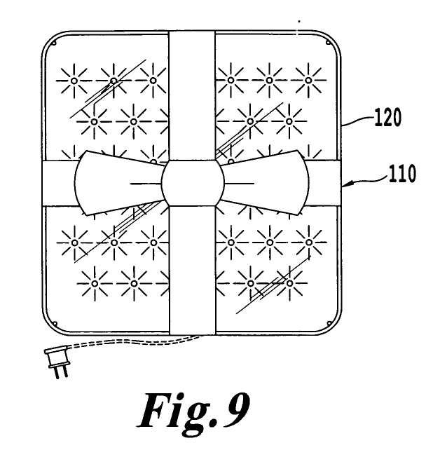

FIGS. 1-8 show an embodiment of the invention where the structure 20 has the shape of a snowman. However, structure 20 may have the shape of any known decoration. For example, FIG. 9 shows a second embodiment 110 of the present invention where the structure 120 has the shape of a gift box. It should be readily apparent to one skilled in the art that other shapes are possible, such as angels, Santa Clauses, Christmas trees, drums, penguins, polar bears, snowflakes, pumpkins, trains, candy canes, stars, and igloos. These modifications are within the scope of the invention as claimed.

It is also noted that apparatus 10 may also include decorative members 80 including secondary light emitting elements 82. As secondary light emitting elements 82 are not located behind diffractive surfaces 30, an observer will not necessarily see a diffraction pattern such as diffraction pattern 34 (described above) when secondary light emitting elements 82 are illuminated.

Obviously, numerous modifications and variations of the present invention are possible in light of the above teachings. It is therefore to be understood that within the scope of the appended claims, the invention may be practiced otherwise than as specifically described herein.

1. A decorative lighting apparatus comprising:
a structure;
a plurality of light emitting elements supported by said structure; and
a diffractive surface connected to said structure such that said plurality of light emitting elements is behind said diffractive surface, said plurality of light emitting elements configured to emit light through said diffractive surface to a viewer, said diffractive surface including a rainbow hologram.

2. The decorative lighting apparatus recited in claim 1, wherein said diffractive surface is transparent.

3. The decorative lighting apparatus recited in claim 1, wherein said diffractive surface is translucent.

4. The decorative lighting apparatus recited in claim 1, wherein at least one of said plurality of light emitting elements is a light bulb.

5. The decorative lighting apparatus recited in claim 1, wherein at least one of said plurality of light emitting elements is a light emitting diode.

6. The decorative lighting apparatus recited in claim 1, wherein said structure has a shape of a snowman.

7. The decorative lighting apparatus recited in claim 1, wherein said structure has a shape of a gift box.

8. The decorative lighting apparatus recited in claim 1, wherein said diffractive surface is on a front face of said structure.

9. The decorative lighting apparatus recited in claim 1, wherein said diffractive surface is on a side face of said structure.

10. The decorative lighting apparatus recited in claim 1, wherein said structure is a metal wire structure with a support member connected to the metal wire structure around a periphery of said support member, said plurality of light emitting elements being connected to said support member.

11. A decorative lighting apparatus comprising:
a structure;
a plurality of means for emitting light supported by said structure; and
means for diffracting light connected to said structure such that said plurality of means for emitting light is behind said means for diffracting light, said plurality of means for emitting light emitting light through said means for diffracting light to a viewer, said means for diffracting light including a rainbow hologram.

12. The decorative lighting apparatus recited in claim 11, wherein said means for diffracting light is transparent.

13. The decorative lighting apparatus recited in claim 11, wherein said means for diffracting light is translucent.

14. The decorative lighting apparatus recited in claim 11, wherein at least one of said plurality of means for emitting light is a light bulb.

15. The decorative lighting apparatus recited in claim 11, wherein at least one of said plurality of means for emitting light is a light emitting diode.

16. The decorative lighting apparatus recited in claim 11, wherein said structure has a shape of a snowman.

17. The decorative lighting apparatus recited in claim 11, wherein said structure has a shape of a gift box.

18. The decorative lighting apparatus recited in claim 11, wherein said means for diffracting light is on a front face of said structure.

19. The decorative lighting apparatus recited in claim 11, wherein said means for diffracting light is on a side face of said structure.

20. The decorative lighting apparatus recited in claim 11, wherein said structure is a metal wire structure with a support member connected to the metal wire structure around a periphery of said support member, said plurality of means for emitting light being connected to said support member.
